(19) United States
(12) Patent Application Publication
(10) Pub. No.: US 2018/0179303 A1
(43) Pub. Date: Jun. 28, 2018

(54) METHOD FOR MANUFACTURING WET RUBBER MASTERBATCH, METHOD FOR MANUFACTURING RUBBER COMPOSITION, AND METHOD FOR MANUFACTURING TIRE

(71) Applicant: TOYO TIRE & RUBBER CO., LTD., Itami-shi, Hyogo (JP)

(72) Inventor: Chiya Nishimura, Itami-shi (JP)

(73) Assignee: TOYO TIRE & RUBBER CO., LTD., Itami-shi, Hyogo (JP)

(21) Appl. No.: 15/739,814

(22) PCT Filed: Feb. 10, 2016
(86) PCT No.: PCT/JP2016/053966

§ 371 Date: Dec. 26, 2017

(30) Foreign Application Priority Data
Aug. 21, 2015 (JP) 2015-163578

(51) Int. Cl. C08C 1/14; C08C 1/04; C08J 3/22; C08J 3/02; C08K 3/32; B60C 1/00

(52) U.S. Cl. CPC C08C 1/14; C08C 1/04; C08J 3/22; C08K 2003/322; C08K 3/32; B60C 1/00; C08J 2315/00; C08J 3/02

(57) ABSTRACT

A problem which is addressed is the provision of a method for manufacturing a wet rubber masterbatch that will serve as raw material for vulcanized rubber which excels in fatigue resistance, ability to achieve reduced heat generation, and tensile characteristics.

A wet rubber masterbatch is manufactured by means of a method comprising an operation in which a latex that has magnesium present therein in an amount which is not greater than 150 ppm is prepared; an operation in which a liquid mixture is made; and an operation in which the liquid mixture is coagulated to obtain a coagulum. The latex comprises rubber particles for which the 90 vol % particle diameter is not greater than 2 μm. The operation in which the liquid mixture is made comprises a step in which the latex and a dispersion solvent are mixed together. The operation in which the liquid mixture is made further comprises a step in which a slurry that contains filler and a latex solution obtained as a result of the step in which the latex and the dispersion solvent were mixed are mixed together. The operation in which the coagulum is obtained comprises a step in which the coagulum is separated from waste liquid. The method for manufacturing the wet rubber masterbatch satisfies Formula I, below.

a/b≥65 (Formula I)

(At Formula I, a indicates COD (mg/L) of waste liquid, and b indicates amount (mass %) of rubber present in the liquid mixture.)

### TECHNICAL FIELD

The present invention relates to a method for manufacturing wet rubber masterbatch, method for manufacturing rubber composition, and method for manufacturing tire.

### BACKGROUND ART

Natural rubber latex is sometimes used as raw material for wet rubber masterbatch. Natural rubber latex contains nonrubber components; e.g., magnesium and other such inorganic components and protein, lipid, and other such organic components (see, for example, Patent Reference No. 1).

Described at Patent Reference No. 1 is art in which natural rubber latex that has been subjected to deproteinization and slurry solution that contains filler are mixed together, protein is compounded with the filler, and a rubber component is thereafter compounded therewith. Described at Patent Reference No. 2 is art in which a wet masterbatch is manufactured by a method including an operation in which natural rubber latex and a slurry that contains carbon black having a 90 vol % particle diameter of not greater than 10 pm are mixed together. Described at Patent Reference No. 3 is art in which pH of a solution prior to addition of acid is adjusted so as to be 7.5 to 8.5. Described at Patent Reference No. 4 is art in which elemental magnesium present in natural rubber latex is removed therefrom. Described at Patent Reference No. 5 is art in which phosphate is added to natural rubber latex following collection thereof and the magnesium phosphate which is produced as a result is removed therefrom.

### PRIOR ART REFERENCES

### Patent References

PATENT REFERENCE NO. 1: Japanese Patent Application Publication Kokai No. 2013-203811
PATENT REFERENCE NO. 2: Japanese Patent Application Publication Kokai No. 2010-150485
PATENT REFERENCE NO. 3: Japanese Patent Application Publication Kokai No. 2015-48416
PATENT REFERENCE NO. 4: WO2010/074245
PATENT REFERENCE NO. 5: Japanese Patent Application Publication Kokai No. 2004-250546

### SUMMARY OF INVENTION

### Problem to be Solved by Invention

However, there is room for improvement with respect to the following points in the art of the prior art references. Because the art of Patent Reference No. 1 is lacking in any stratagem with regard to the particle diameter of the rubber particles and is lacking in any stratagem with regard to pH immediately prior to coagulation, there is room for improvement with respect to achievement of reduced heat generation and the like. Because the art of Patent Reference No. 2 lacks any stratagem with regard to the amount of magnesium and lacks any stratagem with regard to pH immediately prior to coagulation, there is room for improvement with respect to fatigue resistance, tensile characteristics, and the like. The art of Patent Reference No. 3 lacks any stratagem with regard to the amount of magnesium and lacks any stratagem with regard to the COD of the waste liquid. The art of Patent Reference Nos. 4-5 also lacks any stratagem with regard to COD.

The present invention was conceived in light of such situation, it being an object thereof to provide a method for manufacturing a wet rubber masterbatch that will serve as raw material for vulcanized rubber which excels in fatigue resistance, ability to achieve reduced heat generation, and tensile characteristics.

### Means for Solving Problem

The present inventor(s) found that fatigue resistance can be improved by reducing the amount of magnesium. The present inventor(s) also discovered that processing to remove magnesium can have an effect on rubber particle diameter and that dispersion of filler throughout the wet rubber masterbatch becomes nonuniform—and ability to achieve reduced heat generation in the vulcanized rubber is made worse—when rubber particle diameter is too large. The present inventor(s) also came to the realization that the COD of the post-coagulation waste liquid has an effect on the properties of the vulcanized rubber. The present inventor(s) perfected the present invention based on such knowledge.

That is, the present invention relates to a method for manufacturing a wet rubber masterbatch comprising an operation in which a latex that has magnesium present therein in an amount which is not greater than 150 ppm is prepared; an operation in which a liquid mixture is made; and an operation in which the liquid mixture is coagulated to obtain a coagulum. The latex comprises rubber particles for which the 90 vol % particle diameter is not greater than 2 μm. The operation in which the liquid mixture is made comprises a step in which the latex and a dispersion solvent are mixed together. The operation in which the liquid mixture is made further comprises a step in which a slurry that contains filler and a latex solution obtained as a result of the step in which the latex and the dispersion solvent were mixed are mixed together. The operation in which the coagulum is obtained comprises a step in which the coagulum is separated from waste liquid. The method for manufacturing the wet rubber masterbatch satisfies Formula I, below.

a/b≥65 (Formula I)

(At Formula I, a indicates COD (mg/L) of waste liquid, and b indicates amount (mass %) of rubber present in the liquid mixture.)

A method in accordance with the present invention permits manufacture of a wet rubber masterbatch that will serve as raw material for vulcanized rubber which excels in fatigue resistance, ability to achieve reduced heat generation, and tensile characteristics. It is speculated that this is due to there being few crack initiation sites present throughout the vulcanized rubber and/or due to heightened interaction between natural rubber and filler. When magnesium content exceeds 150 ppm, it is not possible to achieve effective improvement with respect to fatigue resistance. When 90 vol % particle diameter exceeds 2 μm, it will not be possible to achieve effective improvement with respect to reduction in fuel consumption. This is likely due to the fact that under such conditions it is speculated there would be nonuniform dispersion of filler. When a/b is below 65, it is not possible to achieve effective improvement with respect to fatigue resistance and tensile characteristics. This is likely due to the fact that under such conditions it is speculated there would be decreased interaction between natural rubber and filler.

The present invention also relates to a rubber composition manufacturing method comprising a method for manufacturing a wet rubber masterbatch. A method in accordance with the present invention permits manufacture of a rubber composition that will serve as raw material for vulcanized rubber which excels in fatigue resistance, ability to achieve reduced heat generation, and tensile characteristics.

The present invention also relates to a tire manufacturing method comprising a rubber composition manufacturing method. A method in accordance with the present invention permits manufacture of a tire that excels in fatigue resistance, ability to achieve reduced heat generation, and tensile characteristics.

### EMBODIMENTS FOR CARRYING OUT INVENTION

### Embodiment 1

A method for manufacturing a wet rubber masterbatch associated with a first embodiment comprises an operation in which a latex is prepared, an operation in which a liquid mixture is made, and an operation in which the liquid mixture is coagulated to obtain a coagulum. The method for manufacturing a wet rubber masterbatch associated with the first embodiment further comprises an operation in which the coagulum is dewatered.

—Operation in Which Latex is Prepared—

The operation in which the latex is prepared comprises a step in which diammonium phosphate is added to latex raw material. The operation in which the latex is prepared further comprises a step in which magnesium phosphate produced as a result of the step in which diammonium phosphate was added to latex raw material is removed. The operation in which the latex is prepared further comprises a step in which stabilizer is added to the latex raw material.

As examples of latex raw material, liquid(s) extracted from rubber tree(s), field latex, and so forth may be cited. Latex raw material may include magnesium, protein, and/or other such nonrubber component(s).

For every 100 parts by mass of latex raw material, it is preferred that diammonium phosphate be added in an amount that is not greater than 1.2 parts by mass, more preferred that this be not greater than 1.0 part by mass, and still more preferred that this be not greater than 0.8 part by mass. Above 1.2 parts by mass, there is a tendency for the 90 vol % particle diameter to exceed 2 μm. For every 100 parts by mass of latex raw material, the lower limit of the range in values for the amount of diammonium phosphate that is added might, for example, be 0.05 part by mass, 0.10 part by mass, or the like. Note that water and/or the like may be further added to the latex raw material.

As stabilizer, ammonia and other such alkalis may be cited as examples.

The latex obtained by the foregoing means comprises rubber particles for which the 90 vol % particle diameter is not greater than 2 μm. Above 2 μm, it will not be possible to achieve effective improvement with respect to reduction in fuel consumption. This is likely due to the fact that under such conditions it is speculated there would be nonuniform dispersion of filler. As examples of the lower limit of the range in values for the 90 vol % particle diameter, 1.0 μm, 1.1 μm, and so forth may be cited. Magnesium is present in the latex in an amount that is not greater than 150 ppm, it being preferred that this be not greater than 140 ppm, and still more preferred that this be not greater than 130 ppm. Above 150 ppm, it will not be possible to achieve effective improvement with respect to fatigue resistance and tensile characteristics. This is likely due to the fact that under such conditions it is speculated there would be many crack initiation sites present throughout the vulcanized rubber and there would be decrease in interaction between natural rubber and filler. As examples of the lower limit of the range in values for the amount of magnesium present in the latex, 40 ppm, 50 ppm, and so forth may be cited. The 90 vol % particle diameter and the magnesium content may be adjusted primarily through adjustment of the amount of diammonium phosphate that is added.

It is preferred that pH of the latex be not less than 9, and more preferred that this be not less than 9.5. Below 9, there is a tendency for tensile characteristics to worsen. This is likely due to the fact that under such conditions it is speculated that because there would be increased tendency for flocculation of protein to occur at surfaces of rubber particles, this would cause there to be decreased interaction between natural rubber and filler. As examples of the upper limit of the range in values for the pH of the latex, 10, 11, and so forth may be cited.

—Operation in Which Liquid Mixture is Made—

The operation in which the liquid mixture is made comprises a step (i) in which the latex and a dispersion solvent are mixed together. The operation in which the liquid mixture is made further comprises a step (ii) in which the latex solution obtained as a result of step (i) and a slurry that contains filler are mixed together. The operation in which the liquid mixture is made further comprises a step (iii) in which, following step (ii), pH is adjusted to as to be not less than 7.

As examples of dispersion solvent, water and other substances that contain water and/or organic solvent may be cited. Of these, water is preferred.

The slurry comprises filler. Filler refers to carbon black, silica, clay, talc, calcium carbonate, magnesium carbonate, aluminum hydroxide, and/or other such inorganic filler(s) ordinarily used in the rubber industry. Among inorganic fillers, carbon black may in particular be favorably employed. As examples of the carbon black, besides SAF, ISAF, HAF, FEF, GPF, and other such carbon blacks ordinarily used in the rubber industry, acetylene black, Ketchen black, and/or other such electrically conductive carbon blacks may be used. The carbon black may be nongranulated carbon black or may be granulated carbon black that has been granulated based upon considerations related to the handling characteristics thereof as is ordinary practice in the rubber industry. The slurry further comprises dispersion solvent.

It is preferred that the solids concentration of the latex solution be 10 mass % to 60 mass %, and more preferred that this be 20 mass % to 30 mass %.

As examples of the method for the mixing at step (ii), agitation methods involving use of high-shear mixers, high shear mixers, homomixers, ball mills, bead mills, high-pressure homogenizers, ultrasonic homogenizers, colloid mills, and other such ordinary dispersers may be cited.

As examples of the method for adjustment of pH at step (iii), methods such as those in which ammonia and/or other such alkali(s) is/are added following mixture of the slurry and the latex solution may be cited.

The liquid mixture obtained by the foregoing means comprises particles. As examples of the particles, rubber particles, filler, and so forth may be cited.

It is preferred that rubber be present in the liquid mixture in an amount that is not less than 10 mass %, and more preferred that this be not less than 20 mass %. It is preferred that rubber be present in the liquid mixture in an amount that is not greater than 60 mass %, more preferred that this be not greater than 50 mass %, and still more preferred that this be not greater than 40 mass %.

It is preferred that pH of the liquid mixture be not less than 7, and more preferred that this be not less than 7.5. Below 7, there is a tendency for tensile characteristics to worsen. This is likely due to the fact that under such conditions it is speculated there would be increased tendency for initiation of coagulation to occur in the liquid mixture and there would be increased tendency for flocculation of protein to occur at surfaces of rubber particles. As examples of the upper limit of the range in values for the pH of the liquid mixture, 9, 10, and so forth may be cited. The pH of the liquid mixture may be adjusted by a method such as addition of ammonia and/or other such alkali(s).

—Operation in Which Liquid Mixture is Coagulated to Obtain Coagulum—

Particles within the liquid mixture are made to coagulate. As examples of the method for causing coagulation, methods in which coagulant(s) is/are added to the liquid mixture, method(s) in which the liquid mixture is agitated, and so forth may be cited. As the coagulant, acid may be cited as an example. As the acid, formic acid, sulfuric acid, and the like may be cited as examples.

The operation in which the coagulum is obtained comprises a step in which the coagulum is separated from waste liquid. Separation of coagulum from waste liquid may be carried out using a filter or the like.

It is preferred that the COD (chemical oxygen demand) of the waste liquid be not less than 2000 mg/L, more preferred that this be not less than 2500 mg/L, still more preferred that this be not less than 3000 mg/L, and still more preferred that this be not less than 4000 mg/L. COD is an indicator of the amount of organic matter that is present within the waste liquid. As examples of the upper limit of the range in values for the COD of the waste liquid, 20000 mg/L and so forth may be cited.

—Operation in Which Coagulum is Dewatered—

Dewatering of the coagulum obtained by the foregoing means is carried out. As the dewatering method, dewatering methods involving use of single screw extruders, ovens, vacuum dryers, air dryers, and other such drying apparatuses may be cited as examples.

The method for manufacturing the wet rubber masterbatch associated with the first embodiment satisfies Formula I, below.

a/b≥65 (Formula I)

(At Formula I, a indicates COD (mg/L) of waste liquid, and b indicates amount (mass %) of rubber present in the liquid mixture.)

If a/b is less than 65, it will not be possible to achieve effective improvement with respect to fatigue resistance and tensile characteristics. This is likely due to the fact that under such conditions it is speculated that because many nonrubber components might remain in the wet rubber masterbatch, this may cause decrease in interaction between natural rubber and filler. On the other hand, as examples of the upper limit of the range in values for a/b, 200, 300, 600, 800, and so forth may be cited.

The wet rubber masterbatch obtained by means of the foregoing operation comprises natural rubber and filler. For every 100 parts by mass of natural rubber, it is preferred that the amount of filler present therein be not less than 10 parts by mass, more preferred that this be not less than 20 parts by mass, and still more preferred that this be not less than 30 parts by mass. Below 10 parts by mass, there is a possibility that improvement of the properties of the vulcanized rubber will not be possible. For every 100 parts by mass of natural rubber, it is preferred that the amount of filler present therein be not greater than 120 parts by mass, more preferred that this be not greater than 100 parts by mass, and still more preferred that this be not greater than 80 parts by mass. Above 120 parts by mass, there is a possibility that there will be poor dispersion of filler, and there is a possibility that improvement of the properties of the vulcanized rubber will not be possible.

A method for manufacturing a rubber composition associated with the first embodiment comprises an operation in which wet rubber masterbatch and compounding ingredient(s) are kneaded together. As examples of compounding ingredients, zinc oxide, stearic acid, antioxidant, wax, oil, silane coupling agent, and so forth may be cited. Rubber may be added as necessary. As examples of rubber that may be added, natural rubber, isoprene rubber (IR), butadiene rubber (BR), styrene-butadiene rubber (SBR), styrene-isoprene rubber, butadiene-isoprene rubber, styrene-butadiene-isoprene rubber, nitrile rubber (NBR), chloroprene rubber (CR), butyl rubber (IIR), and so forth may be cited.

The method for manufacturing the rubber composition associated with the first embodiment further comprises an operation in which a mixture, i.e., the mixture obtained by means of the operation in which wet rubber masterbatch and compounding ingredient(s) are kneaded together, and vulcanizing-type compounding ingredient(s) are kneaded together. As examples of vulcanizing-type compounding ingredients, sulfur, organic peroxides, and other such vulcanizing agents, vulcanization accelerators, vulcanization accelerator activators, vulcanization retarders, and so forth may be cited. As examples of the sulfur, powdered sulfur, precipitated sulfur, insoluble sulfur, high dispersing sulfur, and the like may be cited. Based upon consideration of post-vulcanization rubber properties, endurance, and so forth, it is preferred that the amount of sulfur compounded therein, expressed as equivalent sulfur content, be 0.5 part by mass to 5.0 parts by mass for every 100 parts by mass of the rubber component. As examples of vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited. For every 100 parts by mass of rubber component, it is preferred that the amount of vulcanization accelerator blended therein be 0.1 part by mass to 5.0 parts by mass.

The rubber composition obtained by means of the method associated with the first embodiment may be favorably employed in a tire, and may in particular be favorably employed in a pneumatic tire. The rubber composition may be favorably employed as a tread or other such tire member.

The rubber composition comprises a rubber component. The rubber component comprises natural rubber originating from the wet rubber masterbatch. For every 100 mass % of the rubber component, the amount of natural rubber originating from the wet rubber masterbatch that is present therein is not less than 10 mass %.

A method for manufacturing a tire associated with the first embodiment comprises an operation in which a green tire is made. The green tire comprises the rubber composition. The method for manufacturing the tire associated with the first embodiment further comprises an operation in which the green tire is heated.

—First Variation—

A slurry is made by means of a method comprising a step (I) in which latex and dispersion solvent are mixed, and a step (II) in which the dilute latex solution obtained at step (I) and filler are mixed. Employment of step (I) will permit formation of an extremely thin latex phase on all or part of the surface of the filler, and will make it possible to prevent reflocculation of filler.

### WORKING EXAMPLES

Working examples and the like which illustrate the constitution and effect of the present invention in specific terms are described below. The raw material employed was as follows.

Raw Materials Employed

| | |
|---|---|
| DAP | Diammonium hydrogen phosphate manufactured |
| | by Wako Pure Chemical Industries, Ltd. |
| Coagulant | Formic acid (reagent-grade 85%; diluted to |
| | obtain 10% solution; pH adjusted to 1.2) |
| | manufactured by Nacalai Tesque, Inc. |
| N330 (carbon black) | “SEAST 3” manufactured by Tokai |
| | Carbon Co., Ltd. |
| Flowers of zinc | “Zinc Oxide No. 1” manufactured by |
| | Mitsui Mining & Smelting Co., Ltd. |
| Stearic acid | “LUNAC S-20” manufactured by Kao Corporation |
| Antioxidant A | “NOCRAC 6C” manufactured by Ouchi |
| | Shinko Chemical Industrial Co., Ltd. |
| Antioxidant B | “RD” manufactured by Ouchi Shinko |
| | Chemical Industrial Co., Ltd. |
| Sulfur | “Powdered Sulfur” manufactured by |
| | Tsurumi Chemical Industry Co., Ltd. |
| Vulcanization | “NOCCELER NS-P” manufactured by |
| accelerator | Ouchi Shinko Chemical Industrial Co., Ltd. |

### Comparative Example 1

—Manufacture of Wet Rubber Masterbatch—

Natural rubber latex was collected. Aqueous ammonia was used to adjust the pH of the natural rubber latex so as to obtain the value shown at TABLE 1. Water was added to natural rubber latex to manufacture a natural rubber latex solution having a solids (rubber) concentration that was 28 mass %. 40 parts by mass of carbon black was added to water, and a ROBO MIX manufactured by PRIMIX Corporation was used to disperse the carbon black (ROBO MIX conditions: 9000 rpm; 30 min) to manufacture a carbon black slurry. The natural rubber latex solution was added to the carbon black slurry in such amount as to cause solids (rubber) to be present therein in an amount that was 100 parts by mass. Aqueous ammonia was used to adjust pH so as to obtain the value shown at TABLE 1. A mixer for household use manufactured by SANYO was used to carry out agitation (mixer conditions: 11300 rpm; 30 min) to manufacture a “carbon-black-containing natural rubber latex solution”. The “carbon-black-containing natural rubber latex solution” was maintained at 90° C. while a 10 mass % aqueous solution of formic acid was added thereto in an amount sufficient to achieve a pH of 4. Following completion of coagulation, a filter was used to separate the coagulum from the waste liquid. A Model V-02 screw press (squeezer-type single-screw dewatering extruder) manufactured by Suehiro EPM Corporation was used to dry the coagulum until water content was not greater than 1.5% to manufacture a wet rubber masterbatch.

—Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### Comparative Example 2

—Manufacture of Natural Rubber—

Natural rubber latex was collected, and aqueous ammonia was used to adjust the pH of the natural rubber latex so as to be 10. DAP as a fraction of the total weight of the natural rubber latex was added in the amount shown at TABLE 1, and the magnesium phosphate which precipitated was removed therefrom to obtain a liquid supernatant. Aqueous ammonia was used to adjust the pH of the liquid supernatant so as to obtain the value shown at TABLE 1. Formic acid was added to the liquid supernatant to obtain a coagulum. A Model V-02 screw press (squeezer-type single-screw dewatering extruder) manufactured by Suehiro EPM Corporation was used to dry the coagulum until water content was not greater than 1.5% to manufacture natural rubber.

—Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### Comparative Examples 3-5 and Working Examples 1-9

—Manufacture of Wet Rubber Masterbatch—

Natural rubber latex was collected, and aqueous ammonia was used to adjust the pH of the natural rubber latex so as to be 10. DAP as a fraction of the total weight of the natural rubber latex was added in the amount shown at TABLE 1, and the magnesium phosphate which precipitated was removed therefrom to obtain a liquid supernatant. Aqueous ammonia was used to adjust the pH of the liquid supernatant so as to obtain the value shown at TABLE 1. Water was added to the liquid supernatant to manufacture a natural rubber latex solution having a solids (rubber) concentration that was 28 mass %. 40 parts by mass of carbon black was added to water, and a ROBO MIX manufactured by PRIMIX Corporation was used to disperse the carbon black (ROBO MIX conditions: 9000 rpm; 30 min) to manufacture a carbon black slurry. The natural rubber latex solution was added to the carbon black slurry in such amount as to cause solids (rubber) to be present therein in an amount that was 100 parts by mass. Aqueous ammonia was used to adjust pH so as to obtain the value shown at TABLE 1. A mixer for household use manufactured by SANYO was used to carry out agitation to manufacture a “carbon-black-containing natural rubber latex solution” (mixer conditions for Comparative Examples 3-5 and Working Examples 1-5: 30 min @ 11300 rpm; mixer conditions for Working Examples 6-8: 40 min @ 15000 rpm; mixer conditions for Working Example 9: 50 min @ 18050 rpm). The “carbon-black-containing natural rubber latex solution” was maintained at 90° C. while a 10 mass % aqueous solution of formic acid was added thereto in an amount sufficient to achieve a pH of 4. Following completion of coagulation, a filter was used to separate the coagulum from the waste liquid. A Model V-02 screw press (squeezer-type single-screw dewatering extruder) manufactured by Suehiro EPM Corporation was used to dry the coagulum until water content was not greater than 1.5% to manufacture a wet rubber masterbatch.

—Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### Comparative Example 6

—Manufacture of Natural Rubber—

Natural rubber latex was collected. Aqueous ammonia was used to adjust the pH of the natural rubber latex so as to obtain the value shown at TABLE 1. Formic acid was added to the natural rubber latex to obtain a coagulum. A Model V-02 screw press (squeezer-type single-screw dewatering extruder) manufactured by Suehiro EPM Corporation was used to dry the coagulum until water content was not greater than 1.5% to manufacture natural rubber.

—Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

First Evaluation

—Magnesium Content—

Magnesium content of liquid supernatant—Comparative Examples 2-5 and Working Examples 1-9—was measured in accordance with ISO 11852; 2011. Magnesium content of natural rubber latex—Comparative Example 1 and Comparative Example 6—was measured in accordance with ISO 11852; 2011.

—90 Vol % Particle Diameter—

D90 (μm) of liquid supernatant—Comparative Examples 2-5 and Working Examples 1-9—was measured using a “SALD 2200” manufactured by Shimadzu Corporation (latex refractive index: 1.6-0.10i), absorbance being set to 0.05 to 0.1 at the time of measurement. D90 (μm) of natural rubber latex—Comparative Example 1 and Comparative Example 6—was measured under the same conditions.

—pH—

pH of liquid supernatant—Comparative Examples 2-5 and Working Examples 1-9—was measured using a portable pH meter manufactured by DKK-TOA Corporation. pH of natural rubber latex—Comparative Example 1 and Comparative Example 6—was measured using a portable pH meter manufactured by DKK-TOA Corporation. pH of “carbon-black-containing natural rubber latex solution” was measured using a portable pH meter manufactured by DKK-TOA Corporation.

—COD—

COD of waste liquid was measured in accordance with ISO 6060.

Second Evaluation: Properties of Vulcanized Rubber

The rubber composition was vulcanized at conditions of 150° C. for 30 min to obtain vulcanized rubber. Fatigue resistance, heat generation, and tensile stress of the vulcanized rubber were evaluated. Conditions under which evaluation was performed are as indicated below. Results are shown in TABLE 1.

—Fatigue Resistance—

Performance of vulcanized rubber with respect to fatigue resistance was evaluated in accordance with JIS K 6260 (flex cracking testing). Results of evaluation are shown as indexed relative to a value of 100 for Comparative Example 1. This means that the larger the value the more excellent it was in terms of performance with respect to fatigue resistance.

—Heat Generation—

Heat generation of vulcanized rubber was evaluated using loss tangent tan δ in accordance with JIS K 6265. Measurements were carried out under conditions of 50 Hz, 80° C., and dynamic strain 2% using an E4000 rheospectrometer manufactured by UBM. Results of evaluation are shown as indexed relative to a value of 100 for Comparative Example 1. This means that the smaller the value the lower—and thus the better—was the heat generation.

—Tensile Stress—

Tensile stress was evaluated at an elongation of 300% (hereinafter “M300”) in accordance with JIS K 6261. Results of evaluation are shown as indexed relative to a value of 100 for Comparative Example 1. This means that the larger the value the more excellent it was with respect to tensile stress.

TABLE 1

| | | Compar- | Compar- | Compar- | Compar- | | |
|---|---|---|---|---|---|---|---|
| | | ative | ative | ative | ative | | |
| | | Example | Example | Example | Example | Comparative | |
| | | 1 | 2 | 3 | 4 | Example 5 | Working Example 1 |
| Amount of DAP | | — | 0.8 | 1.5 | 0.4 | 0.4 | 0.4 |
| added mass % | | | | | | | |
| Eval- | Magnesium | 180 | 110 | 50 | 131 | 131 | 131 |
| uation | content ppm | | | | | | |
| | D90 particle | 1.2 | 1.5 | 3.8 | 1.4 | 1.4 | 1.4 |
| | diameter μm | | | | | | |
| | Natural | 10.0 | — | — | — | — | — |
| | rubber | | | | | | |
| | latex pH | | | | | | |
| | Liquid | — | 9.5 | 9.8 | 8.0 | 9.2 | 9.3 |
| | supernatant | | | | | | |
| | pH | | | | | | |

Carbon black-containing natural rubber latex solution (liquid mixture)

| | | | | | | | |
|---|---|---|---|---|---|---|---|
| Eval- | pH | 8.0 | — | 7.9 | 7.1 | 6.7 | 7.5 |
| uation | | | | | | | |

| | | | | | | |
|---|---|---|---|---|---|---|
| Rubber content mass % | 28 | — | 28 | 28 | 28 | 28 |

Waste Liquid

| | | | | | | | |
|---|---|---|---|---|---|---|---|
| Eval- | COD mg/L | 2000 | — | 1966 | 1793 | 1678 | 2480 |
| uation | | | | | | | |

Conditions

| | | | | | | |
|---|---|---|---|---|---|---|
| a/b | 71.4 | — | 70.2 | 64.0 | 59.9 | 88.6 |

Wet rubber masterbatch

| | | | | | | | |
|---|---|---|---|---|---|---|---|
| Blended | Natural | 100 | — | 100 | 100 | 100 | 100 |
| amount | rubber | | | | | | |
| (parts | N330 | 40 | — | 40 | 40 | 40 | 40 |
| by | | | | | | | |
| mass) | | | | | | | |

Rubber composition

| | | | | | | | |
|---|---|---|---|---|---|---|---|
| Blended | Wet rubber | 140 | — | 140 | 140 | 140 | 140 |
| amount | masterbatch | | | | | | |
| (parts | Natural | — | 100 | — | — | — | — |
| by | rubber | | | | | | |
| mass) | N330 | — | 40 | — | — | — | — |
| | Flowers of | 3 | 3 | 3 | 3 | 3 | 3 |
| | zinc | | | | | | |
| | Stearic acid | 2 | 2 | 2 | 2 | 2 | 2 |
| | Antioxidant | 2 | 2 | 2 | 2 | 2 | 2 |
| | (A) | | | | | | |
| | Antioxidant | 1 | 1 | 1 | 1 | 1 | 1 |
| | (B) | | | | | | |
| | Sulfur | 2 | 2 | 2 | 2 | 2 | 2 |
| | Vulcanization | 1 | 1 | 1 | 1 | 1 | 1 |
| | accelerator | | | | | | |

Vulcanized rubber

| | | | | | | | |
|---|---|---|---|---|---|---|---|
| Eval- | Fatigue | 100 | 77 | 95 | 108 | 102 | 124 |
| uation | resistance | | | | | | |
| | (relative to | | | | | | |
| | index value) | | | | | | |
| | Heat | 100 | 112 | 108 | 95 | 96 | 90 |
| | generation | | | | | | |
| | (relative to | | | | | | |
| | index value) | | | | | | |
| | M300 | 100 | 90 | 94 | 98 | 93 | 113 |
| | (relative to | | | | | | |
| | index value) | | | | | | |

| | | Work- | Work- | Work- | Work- | Work- | Work- | Work- | Work- | |
|---|---|---|---|---|---|---|---|---|---|---|
| | | ing | ing | ing | ing | ing | ing | ing | ing | Compar- |
| | | Exam- | Exam- | Exam- | Exam- | Exam- | Exam- | Exam- | Exam- | ative |
| | | ple | ple | ple | ple | ple | ple | ple | ple | Example |
| | | 2 | 3 | 4 | 5 | 6 | 7 | 8 | 9 | 6 |
| Amount of DAP | | 0.8 | 1.1 | 0.4 | 0.4 | 0.4 | 0.4 | 0.4 | 0.4 | — |
| added mass % | | | | | | | | | | |
| Eval- | Magnesium | 110 | 30 | 131 | 131 | 131 | 131 | 131 | 131 | 180 |
| uation | content ppm | | | | | | | | | |
| | D90 particle | 1.5 | 1.9 | 1.4 | 1.4 | 1.4 | 1.4 | 1.4 | 1.4 | 1.2 |
| | diameter μm | | | | | | | | | |
| | Natural | — | — | — | — | — | — | — | — | 10.0 |
| | rubber | | | | | | | | | |
| | latex pH | | | | | | | | | |
| | Liquid | 9.5 | 9.6 | 9.8 | 9.1 | 8.7 | 9.4 | 9.8 | 9.9 | — |
| | supernatant | | | | | | | | | |
| | pH | | | | | | | | | |

Carbon black-containing natural rubber latex solution (liquid mixture)

| | | | | | | | | | | |
|---|---|---|---|---|---|---|---|---|---|---|
| Eval- | pH | 7.6 | 7.4 | 7.4 | 8.0 | 7.6 | 6.8 | 8.0 | 8.3 | — |
| uation | | | | | | | | | | |

| | | | | | | | | | |
|---|---|---|---|---|---|---|---|---|---|
| Rubber content mass % | 28 | 28 | 28 | 28 | 28 | 28 | 28 | 28 | — |

Waste Liquid

| | | | | | | | | | | |
|---|---|---|---|---|---|---|---|---|---|---|
| Eval- | COD mg/L | 2322 | 2354 | 3240 | 3899 | 3718 | 3510 | 4511 | 6927 | — |
| uation | | | | | | | | | | |

Conditions

| | | | | | | | | | |
|---|---|---|---|---|---|---|---|---|---|
| a/b | 82.9 | 84.1 | 115.7 | 139.3 | 132.8 | 125.4 | 161.1 | 247.4 | — |

Wet rubber masterbatch

| | | | | | | | | | | |
|---|---|---|---|---|---|---|---|---|---|---|
| Blended | Natural | 100 | 100 | 100 | 100 | 100 | 100 | 100 | 100 | — |
| amount | rubber | | | | | | | | | |
| (parts | N330 | 40 | 40 | 40 | 40 | 40 | 40 | 40 | 40 | — |
| by | | | | | | | | | | |
| mass) | | | | | | | | | | |

Rubber composition

| | | | | | | | | | | |
|---|---|---|---|---|---|---|---|---|---|---|
| Blended | Wet rubber | 140 | 140 | 140 | 140 | 140 | 140 | 140 | 140 | — |
| amount | masterbatch | | | | | | | | | |
| (parts | Natural | — | — | — | — | — | — | — | — | 100 |
| by | rubber | | | | | | | | | |
| mass) | N330 | — | — | — | — | — | — | — | — | 40 |
| | Flowers of | 3 | 3 | 3 | 3 | 3 | 3 | 3 | 3 | 3 |
| | zinc | | | | | | | | | |
| | Stearic acid | 2 | 2 | 2 | 2 | 2 | 2 | 2 | 2 | 2 |
| | Antioxidant | 2 | 2 | 2 | 2 | 2 | 2 | 2 | 2 | 2 |
| | (A) | | | | | | | | | |
| | Antioxidant | 1 | 1 | 1 | 1 | 1 | 1 | 1 | 1 | 1 |
| | (B) | | | | | | | | | |
| | Sulfur | 2 | 2 | 2 | 2 | 2 | 2 | 2 | 2 | 2 |
| | Vulcanization | 1 | 1 | 1 | 1 | 1 | 1 | 1 | 1 | 1 |
| | accelerator | | | | | | | | | |

Vulcanized rubber

| | | | | | | | | | | |
|---|---|---|---|---|---|---|---|---|---|---|
| Eval- | Fatigue | 128 | 124 | 125 | 130 | 110 | 108 | 135 | 139 | 70 |
| uation | resistance | | | | | | | | | |
| | (relative to | | | | | | | | | |
| | index value) | | | | | | | | | |
| | Heat | 91 | 93 | 88 | 88 | 91 | 96 | 84 | 80 | 115 |
| | generation | | | | | | | | | |
| | (relative to | | | | | | | | | |
| | index value) | | | | | | | | | |
| | M300 | 112 | 110 | 115 | 119 | 106 | 104 | 122 | 127 | 87 |
| | (relative to | | | | | | | | | |
| | index value) | | | | | | | | | |

At Working Example 1, where DAP was 0.4 mass %, fatigue resistance, ability to achieve reduced heat generation, and tensile stress were better than at Comparative Example 1. And at Working Example 2 as well, where DAP was 0.8 mass %, fatigue resistance, ability to achieve reduced heat generation, and tensile stress were better than at Comparative Example 1. And at Working Example 3 as well, where DAP was 1.1 mass %, fatigue resistance, ability to achieve reduced heat generation, and tensile stress were better than at Comparative Example 1.

At Working Example 4, where pH of liquid supernatant was 9.8 (i.e., 0.5 greater than the pH at Working Example 1), fatigue resistance, ability to achieve reduced heat generation, and tensile stress were better than at Working Example 1. And at Working Example 5 as well, where pH of “carbon-black-containing natural rubber latex solution” was 8.0 (i.e., 0.5 greater than the pH at Working Example 1), fatigue resistance, ability to achieve reduced heat generation, and tensile stress were better than at Working Example 1. It is speculated that this may have been due to suppression of flocculation of protein and/or flocculation of latex.

At Working Example 6, fatigue resistance, ability to achieve reduced heat generation, and tensile stress were better than at Comparative Example 1. At Working Example 6, where pH of liquid supernatant was 8.7 (i.e., 0.6 lower than the pH at Working Example 1) and mixer conditions were 40 min @ 15000 rpm (i.e., higher rpm and longer time than at Working Example 1), fatigue resistance and tensile stress were worse than at Working Example 1. The COD at Working Example 6 was higher than the COD at Working Example 1.

At Working Example 7, fatigue resistance, ability to achieve reduced heat generation, and tensile stress were better than at Comparative Example 1. At Working Example 7, where pH of “carbon-black-containing natural rubber latex solution” was 6.8 (i.e., 0.7 lower than the pH at Working Example 1) and mixer conditions were 40 min @ 15000 rpm (i.e., higher rpm and longer time than at Working Example 1), fatigue resistance, ability to achieve reduced heat generation, and tensile stress were worse than at Working Example 1. The COD at Working Example 7 was higher than the COD at Working Example 1.

At Working Example 8, where the pH of liquid supernatant and the pH of “carbon-black-containing natural rubber latex solution” were higher than at Working Example 1 and where mixing was carried out at higher rpm and for longer time than at Working Example 1, fatigue resistance, ability to achieve reduced heat generation, and tensile stress were better than at Working Example 1.

At Working Example 9, where the pH of liquid supernatant and the pH of “carbon-black-containing natural rubber latex solution” were higher than at Working Example 8 and where mixing was carried out at higher rpm and for longer time than at Working Example 8, fatigue resistance, ability to achieve reduced heat generation, and tensile stress were better than at Working Example 8.

At Comparative Example 3, where DAP was 1.5 mass %, fatigue resistance, ability to achieve reduced heat generation, and tensile stress were worse than at Comparative Example 1. It is speculated that this may have been due to nonuniformity in the wet rubber masterbatch at Comparative Example 3 presumably caused by an increased tendency for occurrence of agglomeration.

At Comparative Example 4, tensile stress was worse than at Comparative Example 1. It is speculated that this may have been due to decreased interaction between natural rubber and filler presumably caused by an increased tendency for occurrence of flocculation of protein. At Comparative Example 5, tensile stress was worse than at Comparative Example 1. It is speculated that this may have been due to occurrence of flocculation of latex and/or flocculation of protein.

1. A method for manufacturing a wet rubber masterbatch satisfying Formula I, below, the method comprising:
an operation in which a latex that comprises rubber particles for which 90 vol % particle diameter is not greater than 2 μm and that has magnesium present therein in an amount which is not greater than 150 ppm is prepared;
an operation in which a liquid mixture is made; and
an operation in which the liquid mixture is coagulated to obtain a coagulum;
wherein the operation in which the liquid mixture is made comprises a step in which the latex and a dispersion solvent are mixed, and a step in which a latex solution obtained at the foregoing step and a slurry that contains filler are mixed;
wherein the operation in which the coagulum is obtained comprises a step in which the coagulum is separated from a waste liquid;
wherein Formula I is given by
a/b≥65; and
wherein, at Formula I, a indicates COD of the waste liquid expressed in units of mg/L, and b indicates amount of rubber present in the liquid mixture expressed in units of mass %.

2. The method for manufacturing the wet rubber masterbatch according to claim 1 wherein the operation in which the latex is prepared comprises a step in which diammonium phosphate is added to latex raw material.

3. The method for manufacturing the wet rubber masterbatch according to claim 1 wherein pH of the latex is not less than 9.

4. The method for manufacturing the wet rubber masterbatch according to claim 1 wherein pH of the liquid mixture is not less than 7.

5. A rubber composition manufacturing method comprising the method for manufacturing the wet rubber masterbatch according to claim 1.

6. A tire manufacturing method comprising the method for manufacturing the wet rubber masterbatch according to claim 1.
